(19) United States
(12) Patent Application Publication
(10) Pub. No.: US 2010/0307674 A1
(43) Pub. Date: Dec. 9, 2010

(54) FERRULE FIXTURE

(76) Inventor: Roy MacKay, Kelso (GB)

Correspondence Address: LAMBERT & ASSOCIATES, 92 STATE STREET, BOSTON, MA, 02109-2004, US

(21) Appl. No.: 12/863,385

(22) PCT Filed: Jan. 16, 2009
(86) PCT No.: PCT/GB2009/000139

§ 371 Date: Aug. 25, 2010

Related U.S. Application Data
(60) Provisional application No. 61/063,137, filed on Feb. 1, 2008.

(30) Foreign Application Priority Data
Jan. 17, 2008 (GB) 0800782.5

(51) Int. Cl. B29C 65/54; B32B 38/04; B65D 71/00

(52) U.S. Cl. 156/267; 156/293; 206/223

(57) ABSTRACT

A stainless steel cable typically of 1.5 mm diameter has a ferrule threaded on it. The ferrule is of polypropylene and has a stepped bore, with a small bore portion and a large bore portion. The large diameter portion is arranged at the end of the ferrule adjacent an end of the cable.

To secure the ferrule to the cable, a short length of the ferrule, the cable is unlaid at its end. The result is that the strands of the cable splay out, typically beyond the external diameter of the ferrule. Epoxy resin is applied to the cable at the ferrule and the splayed end. When the adhesive is well distributed, the cable is drawn through the ferrule to introduce the splayed end into the larger diameter portion.

The present invention relates to a method of fixing a ferrule onto a laid-up cable.

Conventionally in window regulators, automobile and horticultural machines and the like, ferrules for use in Bowden cables and the like have been crimped or soldered onto the cable. Such arrangement does not permit ready replacement of the cables outside well equipped factory or workshop premises, due to the requirement for a press or the like to form the crimp.

Surprisingly, I have been able to bond cables into plain bore metal ferrules which have been internally roughened as by threading with a self tapping screw. This is a delicate operation.

I have noted US patent application No. 2004/088847, whose abstract is as follows:

A wire rope and socket combination comprises a wire rope socket, a rope formed of strands of twisted wires extending into the wire rope socket, selected strands of the twisted wires being bent over 180 degrees within the wire rope socket to provide a selected breaking strength; and babbit securing the rope in the wire rope socket. A method of constructing a wire rope socket, the method comprising the steps of: bending selected strands of a rope formed of twisted wires over 180 degrees to form bent strands; inserting the rope and bended strands into a wire rope socket; and pouring molten babbitt into the wire rope socket to secure the rope in the wire rope socket.

Bending back strands of a cable, particular a small diameter cable as used in a window regulator is awkward to my mind.

The object of the present invention is to provide an improved method of fixing a ferrule on a cable.

According to one aspect of the invention there is provided a method of fixing a ferrule onto a laid-up cable, the method consisting in the steps of:
providing a tapered or stepped ferrule having a larger diameter internal bore at one end and a smaller diameter internal bore at the other end,
threading the ferrule onto the cable with the larger diameter internal bore opening towards an end of the cable,
unlaying the end of the cable to cause it to splay out to a transverse size greater than the small diameter internal bore,
applying to the cable, at least at the unlaid portion thereof, adhesive adherent to the cable,
drawing the unlaid portion of the cable, together with adhesive applied to it, into the larger diameter bore end of the ferrule and
allowing the adhesive in the larger diameter bore end to set, whereby the set adhesive holds the end of the cable in its splayed condition in the larger diameter end to resist drawing of the cable from the ferrule via the smaller diameter end.

According to another aspect of the invention, there is provided a kit of parts comprising:
a set of tapered or stepped ferrules, each having a larger diameter internal bore and a smaller diameter internal bore,
a cable sized to pass through the smaller diameter internal bore,
adhesive adherent to the cable and
a set of instructions for performing the method of the first aspect of the invention.

The cable can be of polymeric material, but will normally be of metal, preferably stainless steel. The ferrule can be of polymeric material or other engineering materials, but will normally be of metal, typically stainless steel, aluminium or copper. The adhesive will normally be of the type setting by polymeric action, typically a two part epoxy type or other high strength adhesive. Solder may be used as the adhesive where the materials of the cable and the ferrule are compatible with solder.

The ferrule can be evenly tapered internally, possibly with a straight bore section at one or other end. Alternatively, the ferrule can be stepped with one or more steps in its internal bore.

The invention is particularly applicable to repair of the cables of a window regulator in an automobile, in which case the ferrules and the cable are sized and shaped to be used in a window regulator.

To help understanding of the invention, specific embodiments thereof will now be described by way of example and with reference to the accompanying drawings, in which:

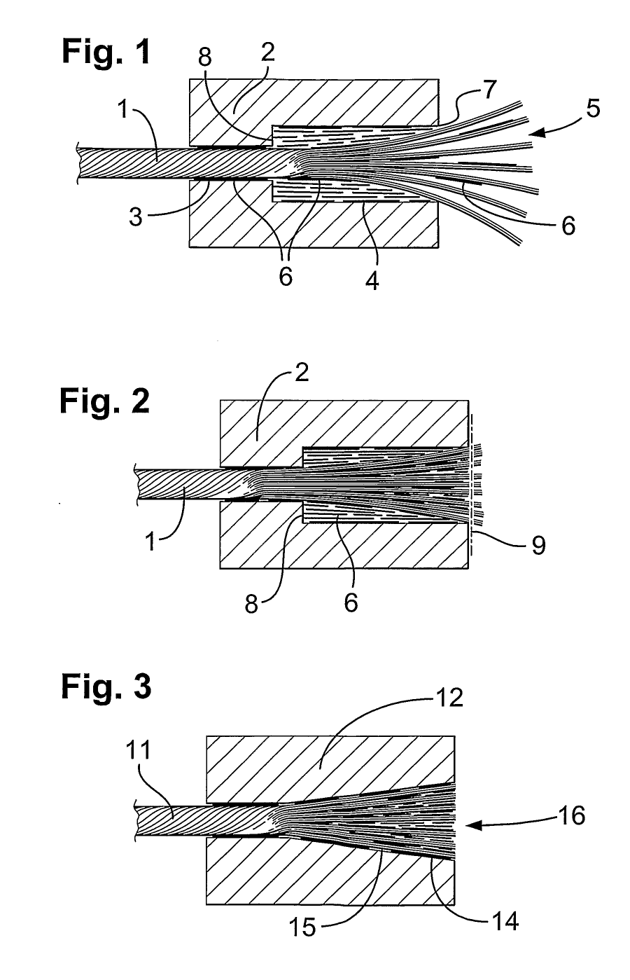

FIG. 1 is a cross-sectional side view of a stepped bore ferrule being fitted to a cable in accordance with the invention;

FIG. 2 is a similar view of the ferrule fixed to the cable;

FIG. 3 is a similar view of a tapered bore ferrule fixed to its cable;

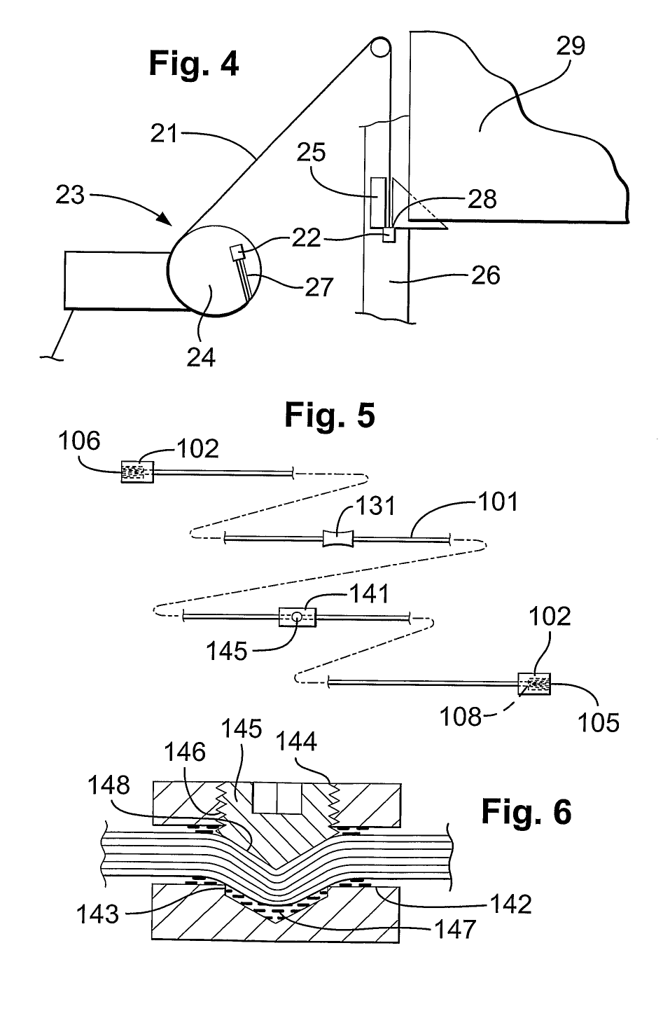

FIG. 4 is a diagrammatic view of a cable fitted with ferrules in accordance with the invention in use in a window regulator;

FIG. 5 is a diagrammatic view of a cable of the invention with four ferrules; and

FIG. 6 is a cross-sectional view o f an intermediate ferrule fixed to the cable of FIG. 5.

Referring to the drawings, a multi-strand stainless steel cable 1 typically of 1.5 mm diameter has a ferrule 2 threaded on it—that is threaded in the manner of a needle on a thread as opposed to screw-threaded. The ferrule is of polypropylene and has a stepped bore, with a small bore portion 3 and a large bore portion 4. The ferrule is 4.2 mm in outside diameter and 6.00 mm in length. The small diameter bore portion is 2 mm long and 1.7 mm in internal diameter, whilst the large diameter bore portion is 4 mm long and 2.7 mm in internal diameter. The large diameter portion is arranged at the end of the ferrule adjacent an end 5 of the cable.

To secure the ferrule to the cable, at its end the latter is first cleaned with isopropyl alcohol to remove any lubricant remaining from its laying up. For a short length of approximately twice the length of the ferrule, the cable is unlaid at its end 5. The result is that the strands of the cable splay out, typically beyond the external diameter of the ferrule. Epoxy resin 6, suitably BONDMASTER available from www.glueline.co.uk, is applied to the cable at the ferrule and the splayed end. To ensure that the adhesive is coating the cable as it passes through the ferrule and the internal bores of the ferrule, this is worked back and forth along the cable. When the adhesive is well distributed, the cable is drawn through the ferrule to introduce the splayed end into the larger diameter portion. Normally the cable will tighten on the smaller diameter portion at the beginning of the splaying, with the splayed strands resting against the large diameter bore at the orifice 7 of this. At the step 8 between the diameters, the adhesive will have been drawn in to occupy any air space that would exist between the cable and the ferrule in the absence of the adhesive. It should also be noted that the use of the large bore portion increases the surface area within the ferrule for the adhesive to adhere to.

Alternatively, it is possible to draw more of the cable through the ferrule, once the cable has tightened on the smaller diameter portion at the beginning of the splaying. The can be achieved particularly by turning the cable in the direction of the twist/lay of the strands. This partially reforms the cable allowing it to be withdrawn into the small bore portion while keeping the cable splayed within the large bore portion. This can allow the drawing of the cable until the splayed end is flush with the end of the ferrule. In addition, this process will squeeze the adhesive out from between the stands helping to fill the internal bores of the ferrule and exclude any air pockets.

Once the adhesive has set, the ferrule will be secured to the end of the cable, with sufficient strength for normal use of the cable, due to mechanical locking of the splayed end and adhesive combination in the stepped ferrule, even if the waxy nature of the polypropylene should tend to inhibit adherence with the ferrule as such. The cable can be trimmed back to the length of the ferrule at 9.

In FIG. 3, the stepped ferrule 2 is replaced by a tapered ferrule 12 having essentially the same dimensions. Whereas in the embodiment of FIGS. 1 to 2, the splayed end of the cable 1 and adhesive forms a rectangular section plug, in the tapered bore, in the tapered bore 14, the splayed end 15 of the cable 11 forms a tapered plug 16. This also is adhered to and mechanically locked in the ferrule.

In FIG. 4, use of a cable 21 having such adhered and mechanically locked ferrules 22 is shown in a window regulator 23 having a winding drum 24 and a cable driven lifter 25 on a track 26. The drum and the lifter have seats 27,28 against which the ferrules seat for operation of the regulator. Driving of the drum—clockwise as shown in FIG. 4—tensions the cable and lifts the window 29.

Turning to FIGS. 5 & 6, the cable 101 is shown with its ferrules in position on it, but for ease of explanation, it is not shown installed in a window regulator, which is the normal state when all the ferrules are fitted. It to has two ferrules 102, which are fitted with splayed ends 105 held in their stepped bores 108 by adhesive 106. Intermediate its ends, it has two further ferrules 131, 141. The first 131 of these is of conventional type, that it is crimped to the cable. The second 141 is fitted at a position chosen in situ. It has a bore 142 for the cable and a radial bore 143, which passes from its outside to the central bore 142 and slightly beyond. The radial bore is larger at 3 mm than the central bore—1.5 mm. The ferrule is 6 mm in diameter. From its opening 144, the radial bore is threaded to the central bore. A grub screw 145 is fitted in the thread 146 of the radial bore. Prior to fitting of the grub screw, the radial bore is filled with adhesive 147. As the screw is inserted, the adhesive is forced sideways along the cable. The ferrule can be worked along the cable to encourage this. During the final tightening of the screw, its point 148 penetrates the cable locally forcing its strands out of alignment with the central bore, thus contributing to securing of the cable in the manner of the ferrules 102.

1. A method in of fixing a ferrule onto a laid-up, wire cable, comprising the steps of:
providing a tapered or stepped ferrule having a larger diameter internal bore at one end and a smaller diameter internal bore at the other end;
threading the ferrule onto the cable with the larger diameter internal bore opening towards an end of the cable;
unlaying the end of the cable to cause it to splay out to a transverse size greater than the small diameter internal bore;
applying to the cable, at least at the unlaid portion thereof, polymeric adhesive adherent to the cable;
drawing the unlaid portion of the cable, together with adhesive applied to it, into the larger diameter bore end of the ferrule;
allowing the adhesive in the larger diameter bore end to set, whereby the set adhesive holds the end of the cable in its splayed condition in the larger diameter end to resist drawing of the cable from the ferrule via the smaller diameter end; and
wherein the ferrules and the cable being sized and shaped to be used in a window regulator.

2. A method as claimed in claim 1, wherein the step of drawing the unlaid portion of the cable into the ferrule includes working the ferrule back and forth along the cable to distribute the adhesive into the ferrule.

3. A method as claimed in claim 1, including the further step of trimming away any strands of the unlaid portion protruding from the large diameter bore.

4. A kit of parts for the repair of a window regulator by performing the method of claim 1, the kit comprising:
a set of tapered or stepped ferrules, each having a larger diameter internal bore and a smaller diameter internal bore and being sized for use in a window regulator;
a cable sized to pass through the smaller diameter internal bore and being sized for use in a window regulator;
adhesive adherent to the cable; and
a set of instructions for performing the method of claim 1.

5. A kit of parts as claimed in claim 4, the kit including a cleaner for cleaning the unlaid portion of the cable prior to application of adhesive.

6. A kit of parts as claimed in claim 4, wherein the cable is of polymeric material.

7. A kit of parts as claimed in claim 4, wherein the cable is of metal.

8. A kit of parts as claimed in claim 7, wherein the cable is of stainless steel.

9. A kit of parts as claimed in claim 4, wherein the ferrule is of metal.

10. A kit of parts as claimed in claim 4, wherein the ferrule is of polymeric material.

11. A kit of parts as claimed in claim 4, wherein the adhesive is of a type setting by polymeric action.

12. A kit of parts as claimed in claim 11, wherein the adhesive is of the epoxy type.

13. A kit of parts as claimed in claim 4, wherein the adhesive is of solder.

14. A kit of parts as claimed in claim 4, wherein the ferrule is tapered from one end to the other.

15. A kit of parts as claimed in claim 4, wherein the ferrule has parallel bores at its ends with a tapered section therebetween.

16. A kit of parts as claimed in claim 4, wherein the ferrule is stepped with one or more internal steps.

17. (canceled)

18. A kit of parts as claimed in claim 4, wherein the cable includes an intermediate ferrule crimped onto it.

19. A kit of parts as claimed in claim 4, including:
a free intermediate ferrule having a through bore and an open radial bore to the through bore; and
a pin complementary with the radial bore for fixing the free ferrule to the cable.

20. A kit of parts as claimed in claim 19, wherein the radial bore is threaded and the pin is a grub screw.

21. A kit of parts as claimed in claim 20, wherein the radial bore has a blind extension opposite its open threaded extent and the radial bore is of larger diameter than the through bore, whereby the grub screw can spread the cable when tightened against it.

22. A kit of parts as claimed in claim 19, wherein the instructions include the step of filling the threaded bore with adhesive prior to tightening the grub screw against the cable.
